(19) United States
(12) Patent Application Publication
(10) Pub. No.: US 2020/0096189 A1
(43) Pub. Date: Mar. 26, 2020

(54) LED LIGHT

(71) Applicant: INSUNG ENPLA CO.,LTD., Incheon (KR)

(72) Inventors: Sung-Jin KIM, Seoul (KR); Tae-Shik YOUN, Seoul (KR)

(21) Appl. No.: 16/141,576

(22) Filed: Sep. 25, 2018

(51) Int. Cl. F21V 29/71; F21V 29/83; F21V 3/02; F21K 9/238

(52) U.S. Cl. CPC F21V 29/713; F21V 29/83; F21Y 2115/10; F21K 9/238; F21V 3/02

(57) ABSTRACT

The present invention relates to a LED lighting device. The LED lighting device comprises second LED substrates and a heat-dissipating frame. The heat-dissipating frame comprises: a frame body formed in a polygonal column shape being open at its upper and lower ends, in which substrate contact surfaces, with which the second LED substrates respectively come into contact, are formed on outer sides of the frame body.

### BACKGROUND OF THE INVENTION

### Field of the Invention

The present invention relates to a method for preparing a carbon nanotube-based heat-dissipating material and a light-emitting diode (LED) lighting device comprising the heat-dissipating material, and more particularly to a method for preparing a carbon nanotube-based heat-dissipating material and an LED lighting device comprising the heat-dissipating material, in which the carbon nanotube-based heat-dissipating material may be used to make a heat sink, thereby reducing the production cost while increasing the heat dissipation efficiency of the heat sink compared to a conventional aluminum heat sink, and makes it possible to maximize the heat dissipation efficiency of a heat-dissipating frame by simple structural modification of the frame.

Moreover, the present invention relates to an LED lighting device, and more particularly to an LED lighting device which shows maximized heat dissipation efficiency through simple structural modification and, at the same time, has improved assembly characteristics, thus facilitating component replacement, and also which improves the uniformity of light.

### Description of the Prior Art

Generally, a lighting device is a device that emits light by converting light energy into electrical energy. With the development of lighting infrastructure and the diversification of lighting applications, 20% of the total electricity is being consumed for lighting purposes, and thus various studies on high-luminance lighting with high energy efficiency have been conducted.

In particular, LED lighting devices have advantages in that they can save energy resources due to their low power consumption and are environmentally friendly materials that can reduce the emission of waste such as mercury and greenhouse gas (CO₂), and in that they can produce various colors and lights and have a long life span. Due to these advantages, these LED lighting devices have been widely used as light source elements for various lighting lamps. However, these LED lighting devices have a disadvantage in that, because they emit highly bright light from a small element, they generate local heat in the element. In particular, when LED chips are installed densely due to the recent trend of miniaturization and integration of products, a problem arises in that the circuit does not operate normally due to the heat generated when light is emitted from the LED, or in that the LED life is shortened and the LED illuminance is lowered.

Namely, when the LED lighting device fails to properly dissipate the heat generated when light is emitted from the LED, the characteristic performance and life span thereof are significantly adversely affect. For this reason, various studies have been conducted to maximize heat dissipation efficiency.

Accordingly, the applicant of the present invention conducted studies on a heat-dissipating frame capable of increasing heat dissipation efficiency and got patents for the heat-dissipating frame (see Korean Patent No. 10-1147962, entitled “LED lighting device”, Korean Patent No. 10-1239123, entitled “LED lighting device”, Korean Patent No. 10-1256865, entitled “LED lamp for lighting”, and Korean Patent No. 10-1200309, entitled “LED lighting device”). These LED lighting devices are configured such that LED modules are mounted on a substrate contact surface formed on a surface having various angles, thereby improving the uniformity of light. In addition, these LED lighting devices are configured such that the ventilation portion of the heat-dissipating frame protrudes toward the outside of a diffusion cover so that the ventilation portion can be exposed to air in order to ensure that heat exchange can actively occur, thereby maximizing heat dissipation efficiency.

However, these LED lighting devices have a disadvantage in that the weight and volume of the products excessively increase due to the high specific gravity of aluminum so that the products have a desired heat dissipation effect, and for this reason, they do not satisfy miniaturization and integration which are recent trends.

In addition, the above-described LED lighting devices have a problem in that the frame is made of highly expensive aluminum that increases the production cost of the product.

In order to solve these problems, the applicant of the present invention filed a patent application for a heat-dissipating frame comprising carbon nanotubes, and got a patent for the heat-dissipating frame.

FIG. 1 is a perspective view showing a heat-dissipating frame disclosed in Korean Patent No. 10-1783392 (entitled “Method for preparing carbon nanotube-based heat-dissipating material and heat-dissipating frame for lighting device comprising the same”).

The heat-dissipating frame (hereinafter referred to as conventional art) 100 shown in FIG. 1 comprises a heat-dissipating plate 101, a heat-dissipating body 103, and heat-dissipating assemblies 105.

The heat-dissipating plate 101 is formed as a disc in which a through-hole that passes through both sides is formed in the center.

The heat-dissipating body 103 is formed in a cylindrical shape which is open at its upper and lower ends and has an air passage hole formed therein. On the outer surface of the heat-dissipating body 103, guide grooves are formed inward, which extends in the vertical direction and are spaced along a circular arc. In addition, the heat-dissipating body 103 is mounted vertically on one side of the heat-dissipating plate 101 such that the air passage hole is connected to the through-hole of the heat-dissipating plate 101.

The heat-dissipating assemblies 105 each comprises: a contact plate with which an LED substrate 111 having LED modules 112 mounted thereon comes in contact; a plate-shaped support vertically connected to one side of the contact plate; and an insertion portion vertically connected to the end of the support and configured to be slidably inserted into the corresponding guide groove.

The conventional art 100 configured as described above has an advantage in that, because the material of the heat-dissipating body 103 and the heat-dissipating assemblies 105 is replaced with a carbon nanotube-based heat-dissipating material, not conventional aluminum, the thermal conductivity, heat release rate and heat release efficiency can be significantly increased.

However, the conventional art 100 has a disadvantage in that, because the heat-dissipating body 103 and the heat-dissipating assemblies 105 are made of the expensive carbon nanotube-based heat-dissipating material, the production cost is increased.

Generally, carbon nanotubes (CNTs) have a disadvantage in that performance thereof is reduced due to modification of the polymer material with the passage of time or upon continued heating, indicating that they have poor long-term stability.

However, the conventional art 100 does not consider this characteristic of carbon nanotubes at all, and has disadvantages in that, because the heat-dissipating body 103 and the heat-dissipating assemblies 105 are all made of the carbon nanotube-based heat-dissipating material, the long-term stability thereof is poor, and when the long-term stability of these components, the corresponding components should be replaced one by one, and for this reason, the assembly characteristics are poor and the component replacement cost increases.

### SUMMARY OF THE INVENTION

The present invention has been made in order to solve the above-described problems, and it is an object of the present invention to provide a LED lighting device, comprising the same, which may maximize the heat dissipation area of a frame body through structural modification and, at the same time, may induce natural convection, thereby efficiently dissipating the heat generated from LED modules.

Another object of the present invention is to provide a LED lighting device, in which the LED lighting device is configured such that auxiliary heat sinks made of the carbon nanotube-based heat-dissipating material are attachable to and detachable from the inner side of a frame body, and thus the heat dissipation effect can be maintained over a long period of time by simply replacing only the auxiliary heat sinks without disassembling other components.

Still another object of the present invention is to provide LED lighting device, comprising the same, which may improve the uniformity of light by forming a front diffusion cover into a curved surface.

Yet another object of the present invention is to provide a LED lighting device, which may further improve the heat dissipation effect by forming discharge grooves on the upper side of a heat sink so as to extend to the outer side.

To achieve the above objects, the present invention provides an LED lighting device comprising second LED substrates and a heat-dissipating frame, wherein the heat-dissipating frame comprises: a frame body formed in a polygonal column shape being open at its upper and lower ends, in which substrate contact surfaces, with which the second LED substrates respectively come into contact, are formed on outer sides of the frame body; and auxiliary heat sinks made of a carbon nanotube-based heat-dissipating material and attachably and detachably provided on inner sides corresponding to the substrate contact surfaces of the frame body.

In the present invention, the frame body further comprises: a through-hole portion formed in a cylindrical shape being open at its upper and lower end and having a through-hole formed therein, the through-hole portion being formed vertically in the center of the internal space of the frame body; and reinforcing walls connecting each inner side of the frame body to the outer circumferential surface of the through-hole portion and extending vertically, wherein an ‘U’-shaped heat-dissipating wing that extends vertically is formed to protrude on one side of the auxiliary heat sinks, which faces toward the through-hole portion when assembled.

In the present invention, auxiliary heat sink insertion grooves are formed on each inner side of the frame body such that they are formed outward from the inner side, extend to the upper end and lower end of the frame body, and are opposite to each other in the widthwise direction; the auxiliary heat sink insertion grooves of the frame body are formed outward from the inner side of the frame body such that the ends thereof extend so as to form extension grooves; and each of the auxiliary heat sinks comprises: a fixing member formed in a bar shape having a length such that the heat-dissipating wing is formed to protrude on one side of the fixing member and the fixing member is slidably inserted into the auxiliary heat sink insertion groove of the frame body in an up-to-down direction when assembled; and insertion members extending laterally from both sides adjacent from the other side of the fixing member and configured to be inserted into the respective extension grooves of the auxiliary heat sink insertion grooves of the frame body.

In the present invention, passage holes, which are formed inward from the outer side and connected to the internal space of the frame body, are respectively formed in extensions between the adjacent substrate contact surfaces of the frame body; the passage holes are formed such that they are respectively connected to the adjacent substrate contact surfaces and extend vertically to the upper end and lower end of the frame body, and thus the adjacent substrate contact surfaces are spaced apart from each other by the passage holes; and plate-shaped auxiliary extensions are formed to protrude in the respective extensions of the frame body such that they protrude outward from the lateral side of each of the adjacent substrate contact surfaces, extend vertically, and are spaced apart from each other so as to externally expose the corresponding passage hole.

In the present invention, at least one bolt hole is formed in the fixing member, and a bolt groove corresponding to the bolt hole of the auxiliary heat sink is formed on the inner sides of the frame body, and thus the frame body and the auxiliary heat sink are fixed by bolt locking; sliding grooves are formed on both sides of the substrate contact surfaces of the frame body such that both sides of the second LED substrates are slidably inserted therein; the LED lighting device further comprises second diffusion covers configured to emit light from the second LED substrate, which are inserted in the sliding grooves of the substrate contact surfaces and come in contact with the substrate contact surfaces; the LED lighting device comprises a power supply device placed in the base; the power supply device comprises a main power supply module configured to supply power to the second LED substrates, and an auxiliary power supply module separably connected to the main power supply module by a connector; the auxiliary power supply module is connected in parallel between the output end of the main power supply model and the second LED substrates, and configured to detect ripple of the main power supply module and remove the rippled from the output voltage when the detected ripple is higher than a predetermined reference value; the LED lighting device comprises a first LED substrate disposed on the upper end of the frame body, and a front diffusion cover configured to emit light emitted the first LED substrate; and the front diffusion cover is formed in a spherical shape being open at one side.

### BRIEF DESCRIPTION OF THE DRAWINGS

FIG. 1 is a perspective view showing a heat-dissipating frame disclosed in Korean Patent No. 10-1783392 (entitled “Method for preparing carbon nanotube-based heat-dissipating material and heat-dissipating frame for lighting device comprising the same).

FIG. 2 is an exploded perspective view showing an LED lighting device according to one embodiment of the present invention.

FIG. 3 is a perspective view showing the heat-dissipating frame of FIG. 2.

FIG. 4 is an exploded perspective view of a portion of the heat-dissipating frame shown in FIG. 3.

FIG. 5 is a top view of FIG. 3.

FIG. 6 is a perspective view showing the frame body of FIG. 3.

FIG. 7 is a perspective view showing the auxiliary heat sink of FIG. 3.

FIG. 8 is a top view illustrating the heat dissipation structure of the heat-dissipating frame of FIG. 3.

FIG. 9(a) is a view illustrating the heat dissipation structure of the heat-dissipating frame and heat sink of FIG. 2, and FIG. 9(b) is a view illustrating another example of FIG. 9(a).

FIG. 10 is a view illustrating a power supply device which is placed in the base of FIG. 2.

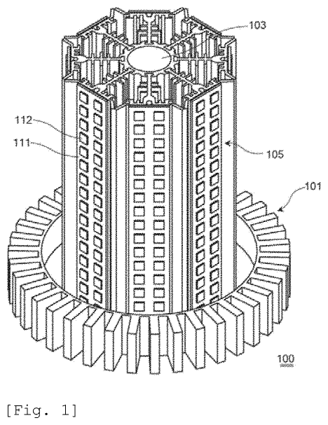

### DETAILED DESCRIPTION OF THE INVENTION

Hereinafter, embodiments of the present invention will be described with reference to the accompanying drawings.

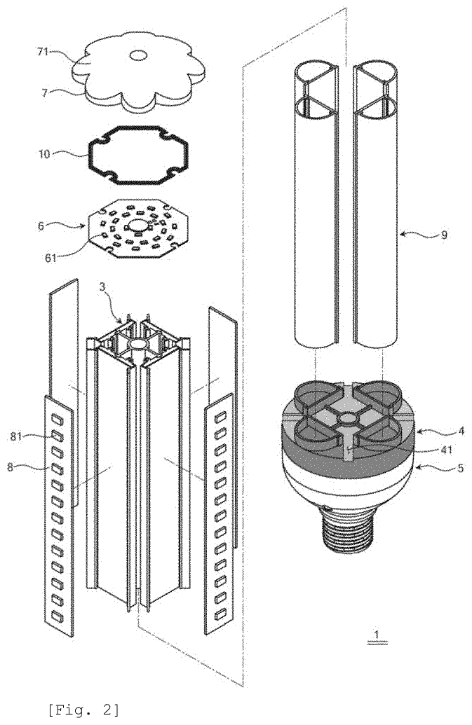

FIG. 2 is an exploded perspective view showing an LED lighting device according to one embodiment of the present invention.

As shown in FIG. 2, an LED lighting device 1 according to one embodiment of the present invention comprises a heat-dissipating frame 3, a heat sink 4, a base 5, a first LED substrate 6, a front diffusion cover 7, second LED substrates 8, side diffusion covers 9, and a packing member 10.

The base 5 is coupled to the bottom of the heat sink 4, has formed at its end a connection portion 51 for connection with an external socket (not shown). Thus, it is configured to supply external power to the LED substrates 6 and 8.

In the base 5, a power supply device 20 to be described below with reference to FIG. 2 is disposed.

The heat sink 4 is coupled to the heat-dissipating frame 3 at its upper side and coupled to the base 5 at its lower end.

In addition, on the upper side of the heat sink 4, a plurality of discharge grooves 41 configured to externally release internal heat are formed.

Furthermore, the upper side of the heat sink 4 is formed in a shape corresponding to the shape of the heat-dissipating frame 3 which comes into contact therewith, so that the heat-dissipating frame 3 can be firmly coupled thereto.

In addition, the heat sink 4 is made of the carbon nanotube-based heat-dissipating material, so that the heat dissipation effect thereof can be maximized.

The first LED substrate 6 is a substrate on which a plurality of LED modules 61 is mounted and a circuit for switching on and off the mounted LED modules 61 is printed. The LED modules 61 are configured to emit light upward.

In addition, the first LED substrate 6 is coupled to the upper end of the heat-dissipating frame 3 and configured to emit light upward. Furthermore, a packing member 10 is provided at a coupling portion between the first LED substrate 6 and the heat-dissipating frame 3, so that the water tightness therebetween can be increased.

The front diffusion cover 7 is formed in a hemispherical shape having an opening at one side. The first LED substrate 6 is inserted into the opening, and the front diffusion cover is configured to diffuse the light emitted from the first LED substrate 6.

At this time, the outer surface of the front diffusion cover 7 is formed into a hemispherical curved surface 71, thus improving the uniformity of light.

The second LED substrates 8 are substrates on which a plurality of LED modules 81 is mounted and a circuit for switching on and off the mounted LED modules 81 is printed.

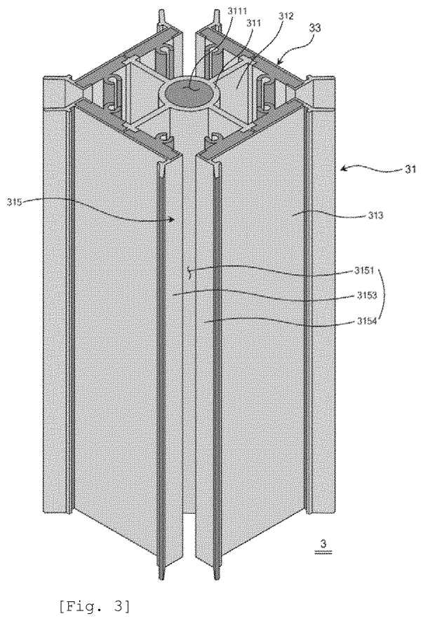

In addition, the second LED substrates 8 are disposed in contact with the respective substrate contact surfaces 313 to be described below with reference to FIG. 3, and thus can emit light laterally at various angles.

The LED modules 81 are configured to emit light laterally.

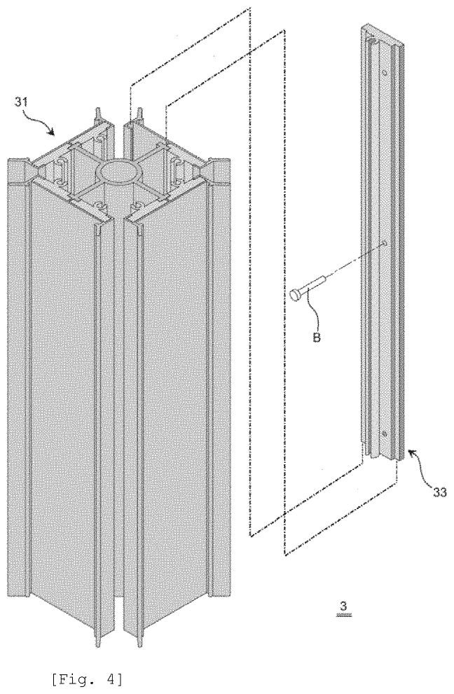

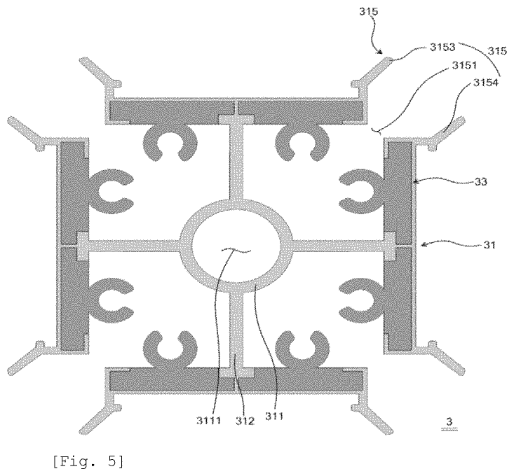

FIG. 3 is a perspective view showing the heat-dissipating frame of FIG. 2; FIG. 4 is an exploded perspective view of a portion of the heat-dissipating frame shown in FIG. 3; and FIG. 5 is a top view of FIG. 3.

As shown in FIGS. 3 to 9, the heat-dissipating frame 3 comprises: a square column-shaped frame body 31 being open at its upper and lower ends and having a space formed therein; and plate-shaped auxiliary heat sinks 33 formed of the carbon nanotube-based heat-dissipating material and coupled to the frame body 31 so as to be attachable to and detachable from the frame body 31.

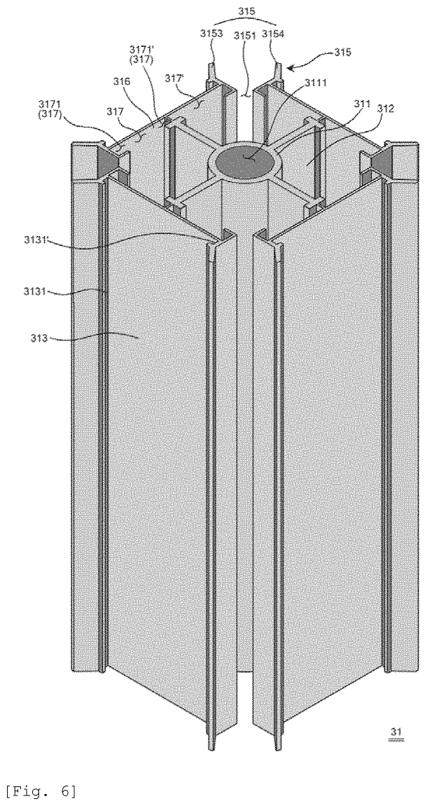

FIG. 6 is a perspective view showing the frame body of FIG. 3.

As shown in FIG. 6, the frame body 31 is formed in a square column shape being open at its upper and lower ends and having a space formed therein. The lower end of the frame body 31 is coupled to the heat sink 4, while the front diffusion cover 7 and the first LED substrate 6 are coupled to the upper end of the frame body 31.

The frame body 31 includes a through-hole portion 311 which has the same length as the frame body. The through-hole portion 311 is open at its upper and lower ends and has a vertical through-hole 3111 formed therein.

At this time, the through-hole portion 311 and each inner side of the frame body 31 are connected to each other by reinforcing walls 312.

This air-through portion 311 is configured such that cold air is introduced through the lower opening while internal hot air is externally discharged through the upper opening, so that air circulation can be activated, thereby effectively achieving heat exchange and heat dissipation of the heat-dissipating frame 3.

Namely, the through-hole portion 311 may receive heat from the frame body 31 through the reinforcing wall 312, and externally discharge the received heat through the through-hole 3111, thereby increasing heat-dissipation efficiency.

In addition, at each side of the frame body 31, a substrate contact surface 313 is formed which is formed of a flat plate and with which each of the second LED substrates 8 comes into contact. In the present invention, for convenience of explanation, an example is described in which the frame body 31 is formed in a square column shape and has four substrate contact surfaces 313. However, it is to be understood that the shape of the frame body 31 is not limited thereto, but may be a cylindrical shape or a polygonal column shape, and the number of the substrate contact surfaces 313 may correspond to the shape of the frame body 31.

In addition, at both sides of each of the substrate contact surfaces 313, sliding grooves 3131 and 3131′ are formed to extend vertically. Both sides of the second LED substrate 8 are slidably inserted into the sliding grooves 3131 and 3131′ of the substrate contact surfaces 313 in an up-to-down direction, thereby improving assembly characteristics. At this time, the substrate contact surface 313 and the second LED substrate 8 are disposed such that the facing sides comes into contact with each other. Into the sliding grooves 3131 and 3131′ of the substrate contact surface 313 on which the second LED substrate 8 is disposed, both sides of the side diffusion cover 9 are further inserted and coupled.

Furthermore, in extensions 315 between the adjacent substrate contact surfaces 313 of the frame body 31, each passage hole 3151 is formed, which extends inward from the outer side and is connected to the internal space. At this time, the passage holes 3151 are formed between the adjacent substrate contact surfaces 313 so as to extend vertically from the upper end to the lower end, and thus the adjacent substrate contact surfaces 313 of the frame body 31 are spaced apart from each other by the passage holes 3151.

These passage holes 3151 of the extensions 315 can further increase the heat dissipation area of the heat-dissipating frame, thereby increasing heat dissipation efficiency.

Furthermore, in each extension of the frame body 31, auxiliary extensions 3153 and 3154 are formed to protrude outward from each side of the adjacent substrate contact surfaces 313 and to extend vertically. At this time, the auxiliary extension 3153 is formed to be spaced apart from the opposite auxiliary extension 3154, so that the passage hole 3151 extends outward, making air circulation more active.

In addition, on the inner side 316 of the frame body 31, auxiliary heat sink insertion grooves 317 and 317′ are formed inward from the inner side 316. The auxiliary heat sink insertion grooves extend vertically from the upper end to the lower end of the frame body 31 and are opposite to each other in the widthwise direction.

In the auxiliary heat sink insertion grooves 317 and 317′, extension grooves 3171 and 3171′ are formed outward from the inner side 316 of the frame body 31 so as to extend to both sides. To the inner side 316 of the frame body 31 between these extension grooves, a heat dissipation wall 312 is connected vertically.

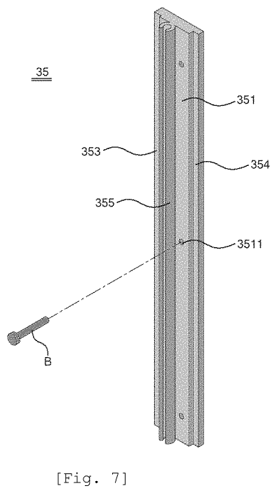

In addition, into the auxiliary heat sink insertion groove 317, an auxiliary heat sink 33 shown in FIG. 7 is slidably inserted in an up-to-down direction. Thus, periodic replacement of the auxiliary heat sink 33 can be achieved in a simple and rapid manner, in view of the fact that the long-term stability of the carbon nanotube-based heat-dissipating material forming the auxiliary heat sink 33 decreases with the passage of time at high temperature.

FIG. 7 is a perspective view showing the auxiliary heat sink of FIG. 4.

The auxiliary heat sink 33 of FIG. 7 is made of the carbon nanotube-based heat-dissipating material described above with reference to FIGS. 2 to 6. It is slidably inserted into the auxiliary heat sink insertion groove 317 of each inner side of the frame body 31 shown in FIG. 6 and comes into contact with the substrate contact surface 313. Thus, the auxiliary heat sink 33 can effectively dissipate the heat transmitted from the second LED substrate through the substrate contact surface 313, and, at the same time, can be periodically replaced.

In addition, the auxiliary heat sink 33 comprises: a bar-shaped fixing member having a length and an area; externally extending insertion members 353 and 354 formed at both sides of the fixing member 351; and an ‘U’-shaped heat-dissipating wing 355 formed to protrude from the front side of the fixing member 351 and extend vertically.

At this time, on the front side of the fixing member 351 of the auxiliary heat sink 33, a plurality of bolt holes 3511 is formed. Thus, when the auxiliary heat sink 33 is inserted into the auxiliary heat sink insertion groove 317 of the frame body 31, it can be more firmly coupled to the frame body 31 by locking of a bolt (B).

In addition, when the auxiliary heat sink 33 is assembled, the fixing member 351 is inserted into the auxiliary heat sink groove 317 of the frame body 31, and the insertion members 353 and 354 are inserted into the extension grooves 3171 and 3171′ of the heat sink insertion groove 317. Thus, even if external shocks and vibrations occur, the insertion members 353 and 354 can be supported by the side wall forming the extension grooves 3171 and 3171′, so that the auxiliary heat sink 33 can be firmly fixed to the frame body 31.

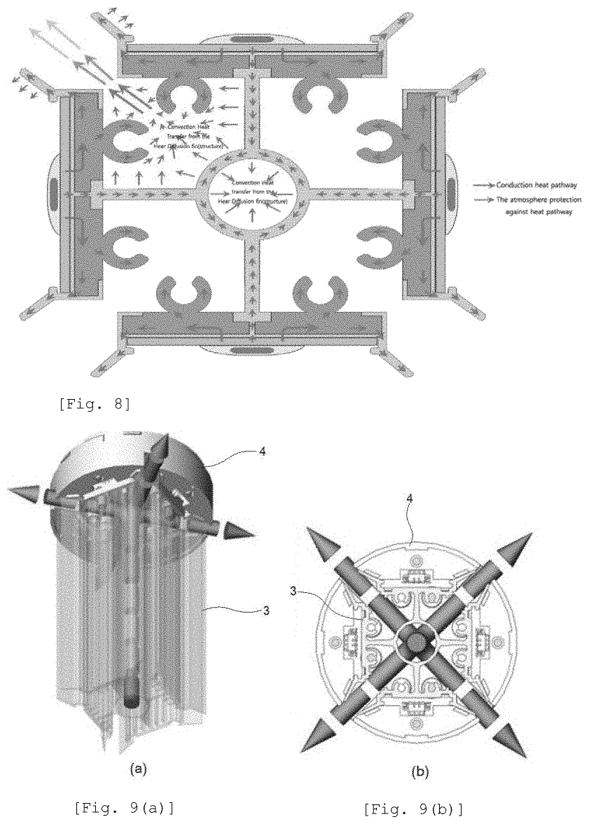

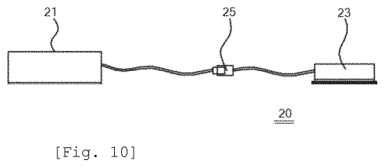

FIG. 8 is a top view illustrating the heat dissipation structure of the heat-dissipating frame of FIG. 3; FIG. 9(a) is a view illustrating the heat dissipation structure of the heat-dissipating frame and heat sink of FIG. 2; and FIG. 7(b) is a view illustrating another example of FIG. 9(a).

As shown in FIG. 8, in the heat-dissipating frame 3, heat generated from the LED module of the second LED substrate is transmitted through the substrate contact surface-> the auxiliary heat sink and the heat-dissipating wall-> the extension and the through-hole portion. At this time, the substrate contact surface of the heat-dissipating frame 3 is formed in a large area while the through-hole portion is formed in the frame, and a passage hole is formed in each extension, thereby maximizing the heat dissipation area of the frame. In addition, the auxiliary heat sink made of the carbon nanotube-based heat-dissipating material is disposed inside each substrate contact surface, so that the heat dissipation efficiency can further be increased.

At this time, hot air which is discharged into the through-hole portion is rapidly heat-exchanged by natural convection in the through-hole, and hot air which is discharged to the outside of the through-hole portion is rapidly discharged externally through the passage holes of the extensions without remaining in the internal space. Thus, the heat generated from the LED can be effectively dissipated.

As shown in FIGS. 9(a) and 9(b), in the heat sink 4 coupled to the lower end of the heat-dissipating frame 3, discharge grooves are formed on the upper side of the heat sink. Thus, air introduced through the through-hole and internal space of the heat-dissipating frame 3 can be rapidly discharged externally.

FIG. 10 is a view illustrating a power supply device which is placed in the base of FIG. 2.

As shown in FIG. 10, a power supply device 20 of the present invention comprises: a main power supply module 21; an auxiliary power supply module 23 connected to the main power supply module 21 and configured to auxiliary power; and a connector 25 connected therebetween. The auxiliary power supply module 23 is connected electrically to the output end of the main power supply module 21 and configured to supply power the LED substrates 6 and 8 by a switching operation.

In addition, the auxiliary power supply module 23 is connected in parallel between the output end of the main power supply module 21 and the LED substrates 6 and 8. When the measurement value of a ripple detected from the output end of the main power supply module is higher than a preset reference value, the auxiliary power supply module may output a ripple-free voltage to the LED substrates, thereby preventing power supply from being abnormally performed due to damage to electrolytic capacitors caused by ripple generation in the main power supply module 23.

Furthermore, the connector 25 is provided for electrical connection or isolation between the main power supply module 21 and the auxiliary power supply module 23.

Namely, the auxiliary power supply module 23 is configured to be connected to or separated from the main power supply module 21 through the connector 25. For this reason, when the auxiliary power supply module 23 has broken down or has trouble, the connector 25 is separated from the main power supply module 21, so that only the auxiliary power supply module 23 can be replaced without replacing both the main power supply module 21 and the auxiliary power supply module, and thus the time required for the replacement operation can be reduced.

As described above, according to the LED lighting device 1 according to one embodiment of the present invention, the heat dissipation area of the frame body can be maximized through structural modification, and at the same time, natural convection can be induced, thereby efficiently dissipating the heat generated from LED modules.

In addition, the LED lighting device 1 of the present invention is configured such that the auxiliary heat sinks made of the carbon nanotube-based heat-dissipating material are attachable to and detachable from the inner side of the frame body, and thus the heat dissipation effect can be maintained over a long period of time by simply replacing only the auxiliary heat sinks without disassembling other components.

Furthermore, according to the LED lighting device 1 of the present invention, the uniformity of light can be improved by forming a front diffusion cover into a curved surface.

In addition, according to the LED lighting device 1 of the present invention, the heat dissipation effect may further be improved by forming discharge grooves on the upper side of the heat sink so as to extend to the outer side.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An LED lighting device comprising second LED substrates and a heat-dissipating frame,
wherein the heat-dissipating frame comprises:
a frame body formed in a polygonal column shape being open at its upper and lower ends, in which substrate contact surfaces, with which the second LED substrates respectively come into contact, are formed on outer sides of the frame body; and
auxiliary heat sinks made of a carbon nanotube-based heat-dissipating material and attachably and detachably provided on inner sides corresponding to the substrate contact surfaces of the frame body.

2. The LED lighting device of claim 1, wherein the frame body further comprises:
a through-hole portion formed in a cylindrical shape being open at its upper and lower end and having a through-hole formed therein, the through-hole portion being formed vertically in the center of the internal space of the frame body; and
reinforcing walls connecting each inner side of the frame body to the outer circumferential surface of the through-hole portion and extending vertically,
wherein an ‘U’-shaped heat-dissipating wing that extends vertically is formed to protrude on one side of the auxiliary heat sinks, which faces toward the through-hole portion when assembled.

3. The LED lighting device of claim 2, wherein auxiliary heat sink insertion grooves are formed on each inner side of the frame body such that they are formed outward from the inner side, extend to the upper end and lower end of the frame body, and are opposite to each other in the widthwise direction;
the auxiliary heat sink insertion grooves of the frame body are formed outward from the inner side of the frame body such that the ends thereof extend so as to form extension grooves; and
each of the auxiliary heat sinks comprises:
a fixing member formed in a bar shape having a length such that the heat-dissipating wing is formed to protrude on one side of the fixing member and the fixing member is slidably inserted into the auxiliary heat sink insertion groove of the frame body in an up-to-down direction when assembled; and
insertion members extending laterally from both sides adjacent from the other side of the fixing member and configured to be inserted into the respective extension grooves of the auxiliary heat sink insertion grooves of the frame body.

4. The LED lighting device of claim 3, wherein passage holes are respectively formed in extensions between the adjacent substrate contact surfaces of the frame body such that they are formed inward from the outer side and connected to the internal space of the frame body;
the passage holes are formed such that they are connected to each of the adjacent substrate contact surfaces and extend vertically to the upper end and lower end of the frame body, and thus the adjacent substrate contact surfaces are spaced apart from each other by the passage holes; and
plate-shaped auxiliary extensions are formed to protrude in each extension of the frame body such that they protrude outward from the lateral side of each of the adjacent substrate contact surfaces, extend vertically, and are spaced apart from each other so as to externally expose the corresponding passage hole.

5. The LED lighting device of claim 4, wherein at least one bolt hole is formed in the fixing member;
a bolt groove corresponding to the bolt hole of the auxiliary heat sink is formed on the inner sides of the frame body, and thus the frame body and the auxiliary heat sink are fixed by bolt locking.

6. The LED lighting device of claim 5, sliding grooves are formed on both sides of the substrate contact surfaces of the frame body such that both sides of the second LED substrates are slidably inserted therein;
the LED lighting device further comprises second diffusion covers configured to emit light from the second LED substrate, which are inserted in the sliding grooves of the substrate contact surfaces and come in contact with the substrate contact surfaces.

7. The LED lighting device of claim 6, wherein at least one bolt hole is formed in the fixing member;
the LED lighting device further comprises a power supply device placed in the base;
the power supply device comprises
a main power supply module configured to supply power to the second LED substrates, and
an auxiliary power supply module separably connected to the main power supply module by a connector;
the auxiliary power supply module is connected in parallel between the output end of the main power supply model and the second LED substrates, and configured to detect ripple of the main power supply module and remove the rippled from the output voltage when the detected ripple is higher than a predetermined reference value.

8. The LED lighting device of claim 7, wherein at least one bolt hole is formed in the fixing member;
the LED lighting device comprises a first LED substrate disposed on the upper end of the frame body, and a front diffusion cover configured to emit light emitted the first LED substrate; and
the front diffusion cover is formed in a spherical shape being open at one side.
